(19) United States
(12) Patent Application Publication
(10) Pub. No.: US 2010/0088220 A1
(43) Pub. Date: Apr. 8, 2010

(54) Systems and Methods for Providing Loan Analysis

(75) Inventor: Chris M. Langley, Port Jervis, NY (US)

Correspondence Address: LAW OFFICES OF MICHAEL L. WISE, LLC, 260 WALSH RD., LAGRANGEVILLE, NY, 12540, US

(73) Assignee: SYPHR LLC, Ferndale, NY (US)

(21) Appl. No.: 12/423,138

(22) Filed: Apr. 14, 2009

Related U.S. Application Data
(63) Continuation-in-part of application No. 12/246,531, filed on Oct. 7, 2008, now abandoned.

(51) Int. Cl. G06Q 40/00

(52) U.S. Cl. 705/38; 705/35

(57) ABSTRACT

A data processing system provides loan analysis for a consumer eligible to receive loan services from a particular financial institution. The data processing system performs the loan analysis by determining every existing loan of the consumer reflected in a credit report from the credit report. Each of the determined existing loans having a loan type that is offered by the particular financial institution is matched with a respective replacement loan available at the particular financial institution. The data processing system then reports a comparison of one or more determined existing loans with one or more matched replacement loans.

### CROSS REFERENCES TO RELATED APPLICATIONS

This is a continuation-in-part application of application Ser. No. 12/246,531, filed Oct. 7, 2008.

### FIELD OF THE INVENTION

The present invention relates generally to systems and methods for financial analysis, and, more particularly, to data processing systems and methods to be performed on data processing systems for loan analysis.

### BACKGROUND OF THE INVENTION

The majority of households in the United States have several outstanding loans. Loans come in several forms, but can be broadly subdivided into two categories. Installment loans are frequently used to buy houses and automobiles. They frequently have a fixed term (i.e., duration) and a fixed monthly payment, and are paid back in accordance with an amortization schedule. Revolving lines of credit, on the other hand, give the consumer a set amount that may be borrowed (i.e., a credit limit). There is no fixed time to pay back any outstanding balance, but there are typically minimum payment requirements. As the consumer pays back the loan, the credit limit “revolves” back up to what it was originally, thereby allowing the consumer to repeatedly access the revolving pool of credit. A credit card is a common form of revolving line of credit.

A loan is defined by its loan parameters (e.g., balance, interest rate, term). The loan parameters available to a consumer for a given loan depend on a range of factors. For a mortgage, for example, these factors may include the consumer's credit and payment history, the consumer's debt-to-income ratio, the property value, the property type, how the property is occupied, the loan amount, the number of points, and market forces such as the federal fund rate. Because some of these factors may vary with time, a given consumer may be eligible to obtain a particular loan with a first set of loan parameters at one point in time, and then be eligible to receive a replacement loan with a very different set of loan parameters at a later point in time. In the interim, for instance, the consumer may have established a better credit score, or the economic climate may have changed so that lower lending rates are available. It is, therefore, beneficial for a consumer to periodically compare the consumer's existing loans against any replacement loans for which the consumer may be eligible. In many cases, refinancing will lead to lower monthly payments and correspondingly better cash flow, and sometimes will even result in lower overall borrowing costs.

Likewise, financial institutions are also interested in having consumers refinance. Doing so may allow a particular financial institution to draw customers away from its competitors, and thereby gain larger market share. Moreover, once a given consumer is an established customer of a particular financial institution, that financial institution often has an easier time selling additional financial products to that consumer. For these reasons, financial institutions invest heavily in advertising in order to attract consumers that may benefit from refinancing.

Nevertheless, despite the potential financial benefits to consumers and the advertising by financial institutions, a typical consumer is unlikely to regularly consider refinancing because they find the research and computations required to make such a financial decision to be inconvenient or daunting. Even existing financial calculators that are readily available to consumers, such as those on the Internet, do not typically help. While these calculators may aid in making financial computations, they still normally require that the consumer input loan parameters manually. The consumer must, as a result, still spend considerable effort in personally collecting data about the consumer's existing loans and available replacement loans in order to obtain a result that can inform a valid refinance decision. For this reason, such financial calculators are time consuming, error-prone, and typically not very compelling to the consumer.

There is, as a result, a need for a loan analysis solution that would allow a large pool of consumers to readily compare their existing loans with relevant replacement loans available at participating financial institutions without the need for the consumer to personally do extensive research and computations. The consumers would benefit by learning about available loan products that may substantially improve their debt configurations. Participating financial institutions would benefit by being exposed to a large number of potential customers without having to incur the high costs of conventional advertising and marketing.

### SUMMARY OF THE INVENTION

Embodiments of the present invention address the above-identified need by providing methods and apparatus that automatically compare a consumer's existing loans with replacement loans available at a particular financial institution that is capable of providing loan services to that consumer.

In accordance with an aspect of the invention, a data processing system provides loan analysis for a consumer eligible to receive loan services from a particular financial institution. The data processing system performs the loan analysis by determining every existing loan of the consumer reflected in a credit report from the credit report. Each of the determined existing loans having a loan type that is offered by the particular financial institution is matched with a respective replacement loan available at the particular financial institution. The data processing system then reports a comparison of one or more determined existing loans with one or more matched replacement loans.

In accordance with one of the above-described embodiments, a loan analysis system (LAS) provides loan analysis to a consumer by interfacing with the consumer over the Internet. After collecting identifying information from the consumer, the LAS matches the consumer with a particular matching financial institution that is capable of providing loan services to that consumer. The LAS then determines all of the consumer's existing loans and the consumer's credit score by extracting this data directly from the consumer's credit report. Using this data, each of the determined existing loans having a loan type that is offered by the matching financial institution is then matched with a respective replacement loan available at the matching financial institution. Based on this matching process, a report is generated that compares one or more of the existing loans with one or more of the replacement loan so that the consumer can more easily determine whether refinancing may be financially beneficial to the consumer. If the consumer so chooses, this report and the credit report information are forwarded to the matching financial institution. The matching financial institution is then free to contact the consumer and pursue a more formal effort to provide refinancing to that consumer.

Advantageously, the above-described embodiment allows the consumer to learn about available loan products that may substantially improve that consumer's debt configuration in a manner that is convenient and does not require the consumer to manually input any loan parameters or perform any financial computations. The matching financial institution, in turn, receives a lead on a consumer who might benefit from becoming a customer of that financial institution.

### BRIEF DESCRIPTION OF THE DRAWINGS

These and other features, aspects, and advantages of the present invention will become better understood with regard to the following description, appended claims, and accompanying drawings where:

FIG. 1 shows block diagram of a LAS and various external elements in accordance with an illustrative embodiment of the invention;

FIG. 2 shows a flow chart of the configuration portion of an illustrative method embodiment for providing loan analysis directly to consumers;

FIG. 3 shows an illustrative set of financial institution matching rules;

FIG. 4 shows an illustrative set of financial institution product parameters;

FIG. 5 shows a flow chart of the loan analysis portion of the illustrative method embodiment for providing loan analysis directly to consumers;

FIG. 6 shows an illustrative Web page that requests indentifying information from the consumer;

FIG. 7 shows an illustrative Web page that provides the consumer with a credit report;

FIG. 8 shows an illustration of a credit report;

FIG. 9 shows an illustrative Web page that provides the consumer with a loan savings report;

FIG. 10 shows a flow chart of the optional loan monitoring portion of the illustrative method embodiment for providing loan analysis directly to consumers;

FIG. 11 shows an illustrative Web page that requests monitoring conditions from the consumer;

FIG. 12 shows a flow chart of the configuration portion of an illustrative method embodiment for providing loan analysis directly to financial institutions; and

FIG. 13 shows a flow chart of the loan analysis portion of the illustrative method embodiment for providing loan analysis directly to financial institutions.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

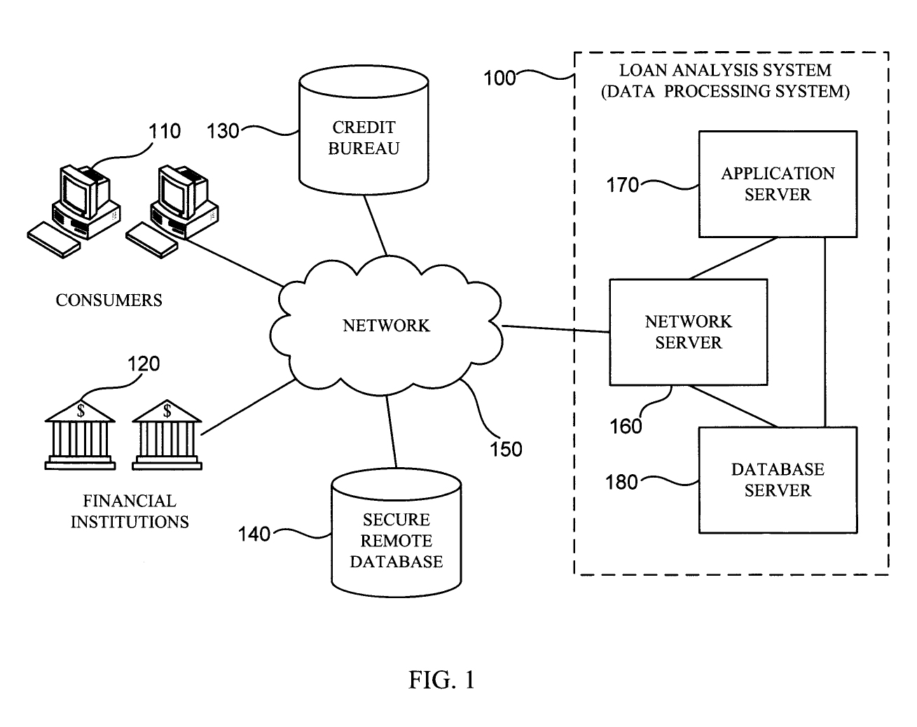

FIG. 1 shows a LAS 100 for providing loan analysis in accordance with an illustrative embodiment of the invention. The illustrative LAS is connected to several external elements, namely consumers 110, financial institutions 120, a credit bureau 130, and a secure remote database 140 via a network 150. The LAS itself comprises a network server 160, an application server 170, and a database server 180. These three servers combine to form a data processing system, and each server performs a particular function within the LAS. More specifically, the network server is operative to receive and transmit data over the network between the LAS and the external elements. The application server comprises a data processor and is operative to perform the logical steps and computations associated with the loan analysis operations, and to generate analysis data. Finally, the database server comprises a memory and is operative to store data associated with the loan analysis operations. The network, application, and database servers may comprise, for example, AS/400®, iSeries®, or i5® servers available from International Business Machines Corporation (Armonk, N.Y., USA), or any analogous server-type computers.

It should be noted that the three servers 160, 170, 180 forming the LAS 100 may, in fact, be implemented in a single computer or implemented in several linked computers. Their presentation as three separate elements in FIG. 1 is merely to draw attention to their functionality rather than to present their physical form. Once this novel functionality is understood, the programming of the computer or computers to implement the functionality will be well within the ability of one of ordinary skill in the art.

The network 150 preferably comprises the Internet (i.e., World Wide Web), allowing the consumers 110 to access the LAS 100 using any internet-capable computer with a Web browser program, such as a personal computer, cellular telephone, or personal digital assistant. This allows the LAS to present its loan analysis content to consumers in the form of Web pages. Accordingly, computer-to-computer communications between the LAS and the consumers is preferably performed using the Hypertext Transfer Protocol (HTTP) or, alternatively, the Secure Sockets Layer (SSL) Protocol. For communication between the LAS and the other external elements 120, 130, 140, the Internet may also be utilized or a more private network connection may be chosen. Alternative network connections may include, as just a few examples, point-to-point (leased line), circuit switched, or packet switched Wide Area Networks (WANs).

As will described in greater detail below, the financial institutions 120 voluntarily subscribe to the LAS 100 to become “participating” financial institutions in order to gain exposure to consumers 110 that may be interested in acquiring one or more new loans. As used herein, the term “financial institution” is used broadly and encompasses any formal institution that regularly acts to lend money to consumers. A “particular” financial institution, in turn, is meant to comprise an entire commercial entity rather than, for example, its individual branch locations. Moreover, the term “loan” as used herein is intended to encompass an amount of money advanced to a consumer, to be repaid at a later date with interest. A loan may be defined by its loan parameters. The loan parameters that define a given loan may include, for example, some or all of, loan type, original balance, term, interest rate, monthly payment, balance remaining, and remaining term. In some cases, one loan parameter may be derived from other loan parameters and, therefore, may not comprise an independent variable. There are several conventional and commonly available loan types including mortgages, home equity loans, home equity lines of credit, automobile financing loans (i.e., auto loans), credit cards, personal loans, and several others.

The participating financial institutions 120 may, therefore, comprise conventional banks. But, as will also be detailed to a greater extent below, the LAS 100 is particularly well suited to serving credit unions. Credit unions in the United States are typically not-for-profit cooperative financial institutions that are owned and controlled by their members, and operated for the purpose of promoting thrift, providing credit at reasonable rates, and providing other financial services to their members. United States regulatory agencies require that credit unions restrict their membership to defined segments of the population, such as people who live, worship, or attend school in a well-defined geographic area; employees of specific companies or trades; members of specific non-profit groups; or a particular occupational group (e.g., teachers or doctors). In accordance with conventional nomenclature, these restrictions on membership are referred to herein as “fields of membership.” Credit unions typically have a much smaller share of the financial services market than conventional banks and, therefore, have lower discretionary funds to use for advertising and marketing. As a result, a credit union may find the LAS's capability to expose consumers falling within that particular credit union's field of membership to the credit union's financial products highly attractive.

The credit bureau 130 and the secure remote database 140 are the remaining elements to be described in FIG. 1. The credit bureau comprises one or more databases that store credit history data for the consumers 110. The databases may, for example, be populated with consumer credit history data collected by one or more of the three largest credit bureaus, namely Experian® (West Orange, Calif., USA), TransUnion® (Chicago, Ill., USA), and Equifax® (Atlanta, Ga., USA). The secure remote database, on the other hand, is a database external to the LAS that, in the present illustrative embodiment, is primarily tasked with storing sensitive financial information about the consumers for use by the financial institutions 120. Such sensitive information may include, for example, the data gleaned from the consumers' credit report. Safeguards such as data encryption and other methodologies known in the art are preferably utilized to protect data stored in the secure remote database. The secure and remote nature of the secure remote database is utilized in response to governmental regulatory requirements and consumer expectations for securing this kind of sensitive personal information.

The function of the different elements in FIG. 1 will now be described with reference to an illustrative “direct-to-consumer” method embodiment for providing loan analysis for consumers in accordance with aspects of the invention. For ease of understanding, the illustrative method can be broken up into two portions: a configuration portion, and a loan analysis portion.

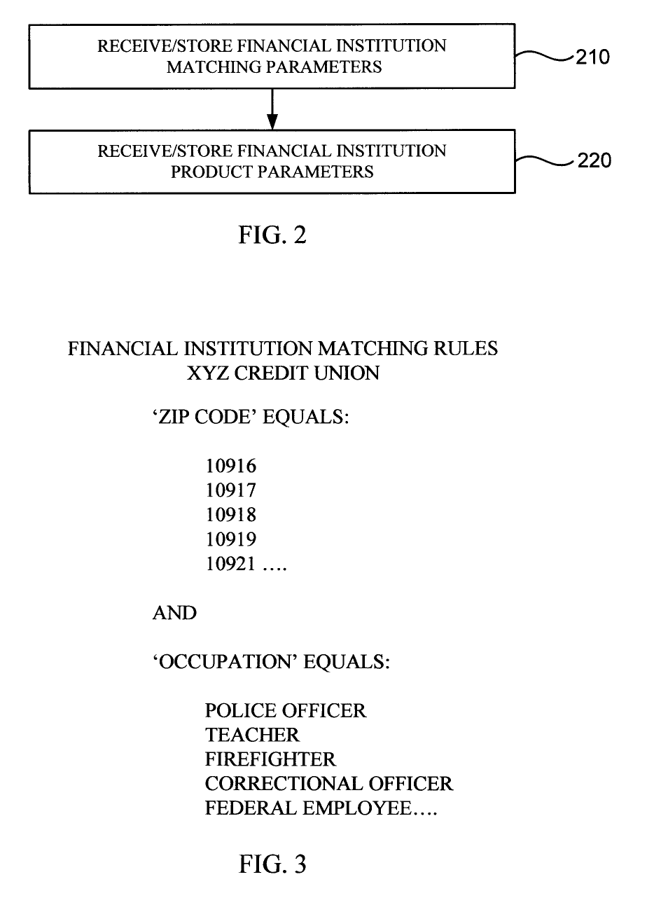

FIG. 2 shows a flow chart of the configuration portion of the direct to consumer method embodiment wherein the LAS 100 receives and stores data from each of the participating financial institutions 120 for later use in servicing consumers 110. In step 210, the LAS receives and stores a set of financial institution matching rules (FIMRs) for each of the participating financial institutions. Each set of FIMRs, in turn, comprises one or more rules that define the type of consumer to whom the respective financial institutions may provide loan services. Where the participating financial institution is a credit union, for example, the FIMRs may be determined by the credit union's field of membership. FIG. 3 shows a set of FIMRs for an exemplary credit union “XYZ Credit Union.” The FIMRs in this particular example limit eligible consumers to those that have a zip code and a particular occupation falling within the listed values. A consumer who resides in zip code 10917 and whose occupation is a “correctional officer,” for instance, would be eligible to be serviced by the XYZ Credit Union. Consumers having an unrepresented zip code or unrepresented occupation, on the other hand, would be excluded. The FIMRs are preferably stored in the database server 180 of the LAS.

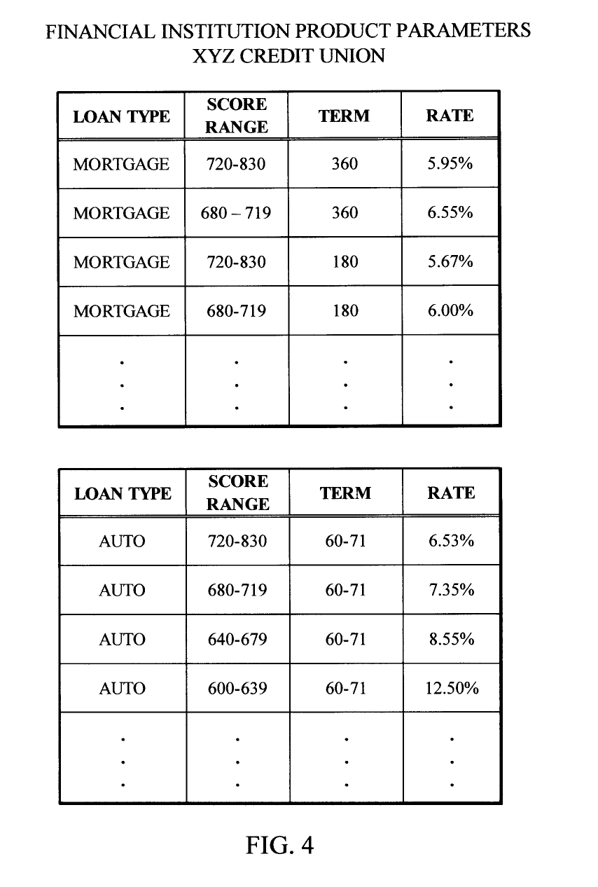

In step 220, additional parameters are received and stored by the LAS 100, in this case, financial institution product parameters (FIPPs). Like the FIMRs, a separate set of FIPPs is stored for each participating financial institution 120. An example of the FIPPs for the illustrative XYZ Credit Union are shown in a simple lookup-table format in FIG. 4. The tables include a row for each loan product provided by the financial institution. A loan is defined in the tables by its loan type, consumer credit score range (“score range”), term, and interest rate (“rate”). As is the case for the credit score range, the term is also presented as a range rather than a single value in some rows of the tables (e.g., Auto Loans), thereby reducing the number of rows. Like the FIMRs, the FIPPs are also preferably stored in the database server 180.

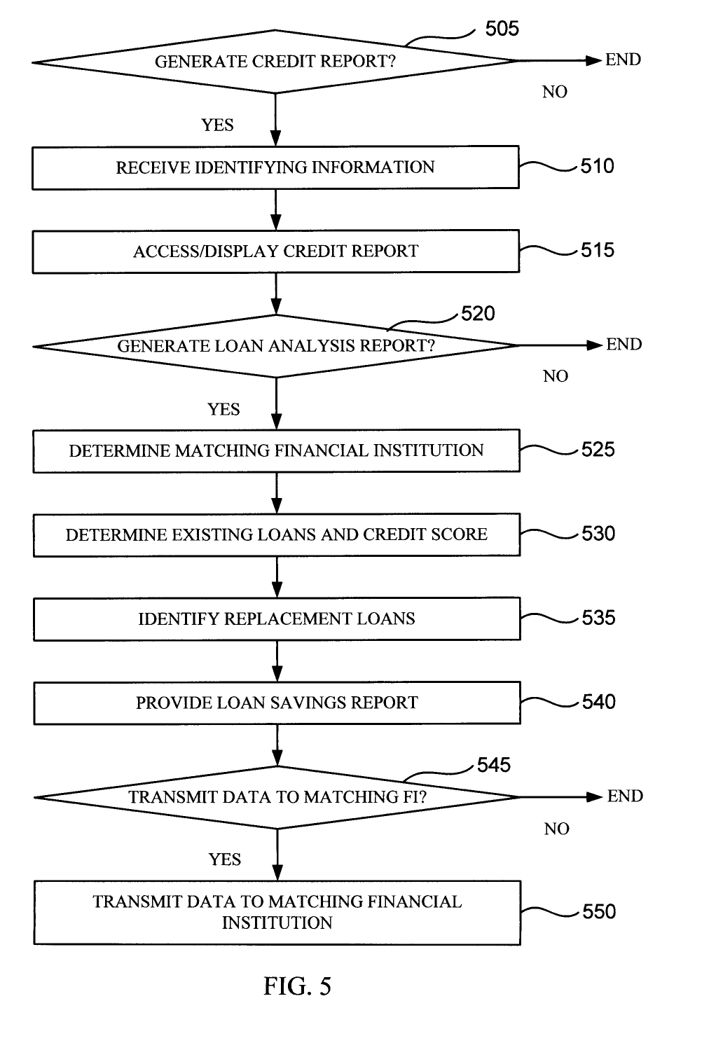

FIG. 5 goes on to show the loan analysis portion of the illustrative direct-to-consumer method embodiment. This portion is performed after a consumer 110 accesses the Web site of the LAS 100 (in this particular embodiment, “www.saveonyourloans.com”). In step 505, the LAS offers to provide the consumer with the consumer's credit report. Many consumers will periodically order their credit reports in order to determine the status of their existing debts, their credit scores, whether the reports contain any errors, and whether there are any indications of identity fraud. If the consumer indicates that the consumer desires to receive the credit report, the method moves on to step 510 and LAS obtains identifying information from the consumer. This may be performed by querying the consumer for the consumer's name, address, social security number, birth date, and other such identifying information. The LAS also preferably queries the consumer for information that may be used to later match the consumer with a financial institution able to provide loan services to that consumer. More specifically, the LAS queries the consumer for identifying information that may be matched with the FIMRs provided by the participating financial institutions in step 210 (e.g., occupation, location of work, place of worship, membership in organizations). In some cases, it may be advantageous to present drop-down menus to the consumer to restrict the possible responses. Once this identifying information is received, the LAS accesses the credit bureau and obtains the credit report. The LAS then displays that credit report for the consumer, as indicated in step 515. In accordance with step 520, the LAS also queries the consumer whether the consumer wants to obtain a loan savings report. In the illustrative embodiment, the loan savings report, thereby, becomes a value-added feature that may optionally be accessed by the consumer after obtaining a credit report.

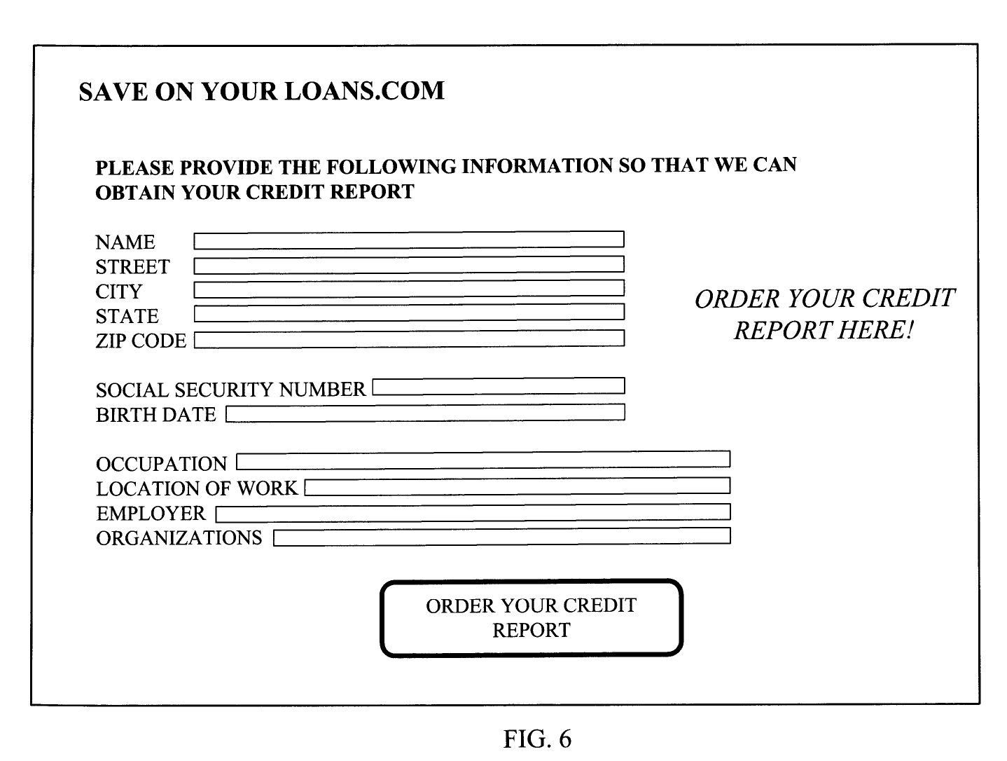

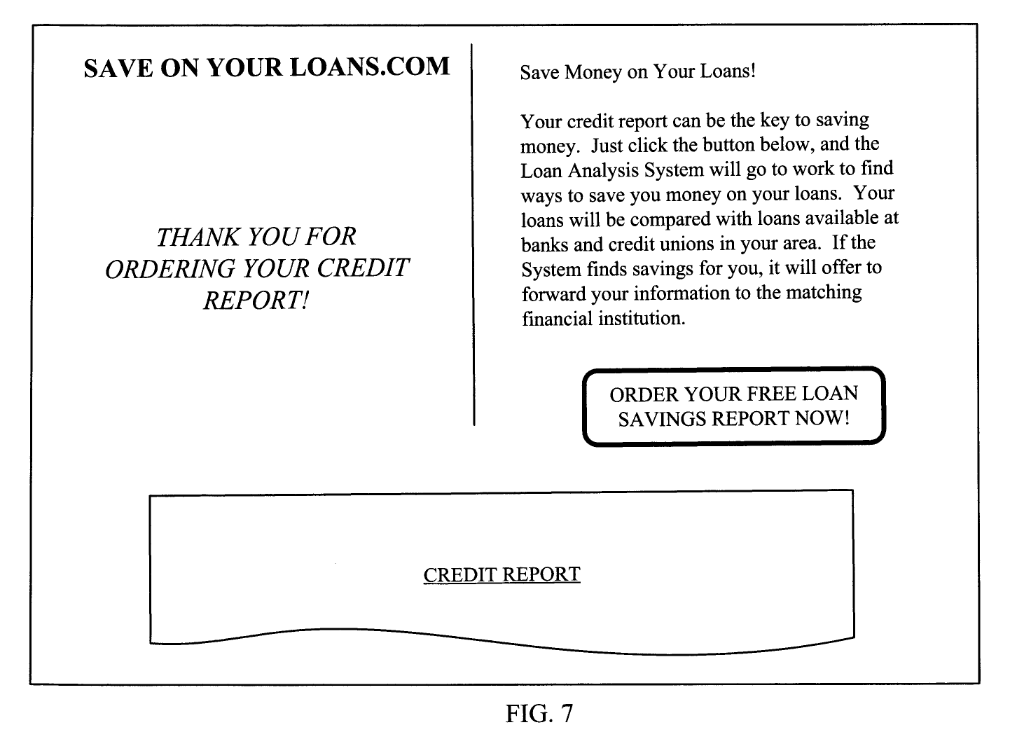

FIG. 6 shows an illustrative Web page that might be presented to the consumer 110 during step 510. As described above, this page queries the consumer for identifying information that both is useful for obtaining a credit report for the consumer and may be useful in matching the consumer with a particular financial institution capable of providing loan services to that consumer. FIG. 7, in turn, shows an illustrative Web page that might be presented to the consumer at the conclusion of steps 515 and 520. The Web page shows the consumer's credit report. The Web page also provides some content that offers the consumer the option of receiving a loan savings report.

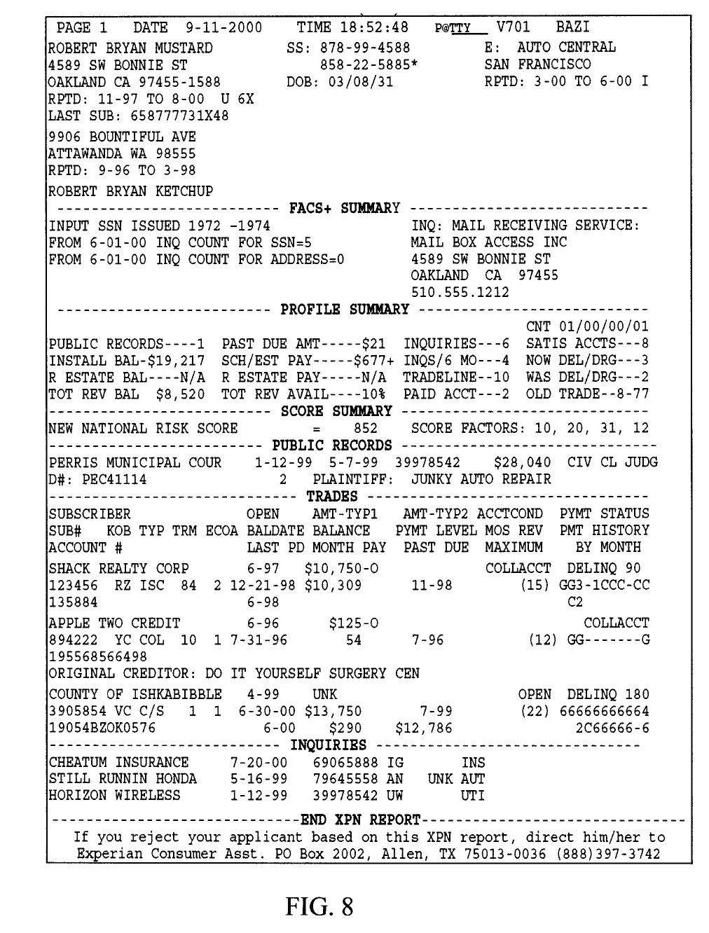

FIG. 8 shows additional details of what a credit report obtained in step 515 might look like. This particular credit report is in a text format that is typical of credit reports generated by Experian. Credit reports provided by other credit bureaus may be formatted somewhat differently, but typically include similar information. The report has several elements and codes that will be familiar to one skilled in the art and that are readily understood by reference to descriptive materials available from the credit bureaus and elsewhere. Briefly, in addition to personal data such as name and address, the report describes the consumer's public records on bankruptcies, liens, and civil law suits. In addition, the consumer's loan history, including existing and past loans, is presented in what are normally called “tradelines” or “trades.” The credit report may also present information on “hard” inquiries made by third parties (e.g., lenders) to the credit bureau, as well as the consumer's credit score.

As can be seen in the credit report sample shown in FIG. 8, the tradelines (trades) provide detailed loan parameters for each of the consumer's existing loans. The tradelines, for example, provide the loan type, original balance, term, opening date, monthly payment, last payment, payment status, and several other descriptive parameters.

A consumer's credit score is a numerical value that represents the perceived creditworthiness of that consumer. It is typically based on a statistical analysis of a consumer's credit report information. There are different methods of calculating credit scores. FICO® is a credit score developed by Fair Isaac Corporation (San Rafael, Calif., USA). It is used by many financial institutions that use a risk-based system to determine the possibility that the consumer may default on a financial obligation. Many credit bureaus also have their own proprietary credit scores. The FICO scoring system presently ranges from 501-990, with a higher value being indicative of better perceived creditworthiness.

If the consumer 110 chooses to receive a loan savings report in step 520, the FIG. 5 method proceeds to step 525. In this step, the LAS 100 matches the particular consumer with a particular financial institution 120 (the “matching financial institution”) from which the consumer is eligible to receive loan services. As described above, it does so by inserting all or some of the consumer's identifying information obtained in step 510 into the sets of FIMRs obtained in step 210 in order to obtain a matching financial institution solution.

Next, in step 530, the LAS 100 identifies the consumer's existing loans. In accordance with aspects of the invention, it does so by reference to the credit report obtained in step 515. More specifically, the LAS parses the data presented in the credit report's tradelines to determine every existing loan of the consumer represented in the credit report. In doing so, the LAS determines at least six loan parameters for each existing loan, namely, the loan type, term, opening balance, existing interest rate, and existing monthly payment. Several of these loan parameters are explicitly included in the tradelines and can be extracted directly therefrom. Those not explicitly presented may be determined from the presented tradeline parameters using conventional and well known financial formulae. For example, existing interest rate may be derived from opening balance, term, and monthly payment. Thus, the LAS determines the existing loans exclusively from the credit report. The consumer is not asked to input any existing loan data manually.

Step 530 also identifies the consumer's credit score from the credit report when such a score is present in the report. If a score is not present, the LAS 100 may instead calculate a representative credit score itself based on the data presented in the credit report using an algorithm that attempts to emulate one of the proprietary credit scores provided by the credit bureaus 130.

The parsing of the credit report to determine the existing loans and credit score is performed by conventional data processing methods that will be familiar to one of ordinary skill in the art. Although not the only method coming within the scope of this invention, in the present embodiment, the credit report data is initially converted into an Extensible Mark-up Language (XML) format in conformity with specifications provided by the Mortgage Banker's Association of America Mortgage Industry Standards Maintenance Organization (MISMO). In this manner, credit report data provided by different credit bureaus is normalized and provided with standardized XML descriptors and wordings. Commercial software, such as the MERit Credit Engine from Merit Credit Systems, Inc. (Montrose, Calif., USA), is available to perform this kind of processing on credit report data. Once so formatted, the LAS 100 can easily cycle through the XML data and extract the desired loan parameters and credit score from the data. The XML format is also a convenient format for storing the credit report data for later use. In the present example, the data may be stored in the secure remote database 140.

In step 535, the LAS 100 matches each of the determined existing loans having a loan type that is offered by the matching financial institution 110 with a respective replacement loan available at the matching financial institution. The matching is performed by reference to the FIPPs lookup tables that were populated in step 220. The matching is performed in two substeps. For a given existing loan, the LAS first considers all the replacement loans of the same loan type available as the existing loan and available to the consumer for that consumer's credit score. This identifies a subset of available replacement loans. The LAS then, if possible, chooses a particular replacement loan among this subset with the same term as the remaining term of the existing loan. If no replacement loan within the subset has exactly the same term as the remaining term of the existing loan, the replacement loan with the nearest term that is longer than the existing loan is chosen. In this particular embodiment, the longer replacement loan is chosen because a longer term loan tends to reduce monthly payment amounts more than a shorter replacement loan. Nevertheless, other rules may be utilized to choose replacement loans with non-matching terms (e.g., replacement loans with shorter terms may be chosen instead).

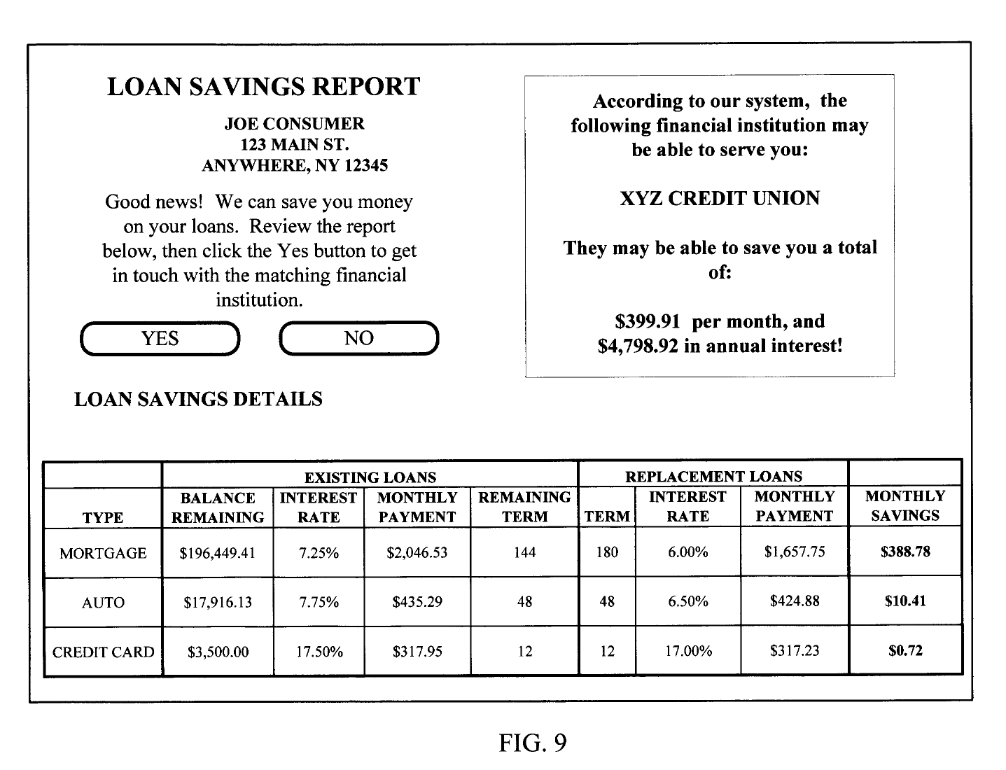

The LAS 100 then, in step 540, provides a loans savings report to the consumer 110 that compares one or more determined existing loans with one or more matched replacement loans. FIG. 9 shows an illustrative example of such a loans savings report, which is provided to the consumer in the form of a Web page. In addition to other information, the illustrative loan savings report provides a table that compares the loan parameters of three existing loans with respective parameters of three respective replacement loans. More specifically, the table compares the balance remaining, interest rate, existing monthly payment, and remaining term of each existing loan with the term, interest rate, and monthly payment of the respective matched replacement loan. In this manner, the loan savings report provides a compelling and convenient example of the money that the consumer may save by refinancing at the matched financial institution. And, again, the consumer has not had to manually enter any financial information to obtain this loan analysis.

With this compelling information in hand, it is probable that the consumer 110 may desire to pursue some or all of the replacement loans at the matching financial institution 120. As a result, in step 545 the consumer is offered the opportunity to have the loan savings report and credit report data sent to the matching financial institution. In the present embodiment, this option also appears on the loan savings report Web page shown in FIG. 9. If the consumer chooses this option, the LAS 100 transmits the loan savings report and credit report data to the matching financial institution, as indicated in step 550. The matching financial institution is then free to contact the consumer and pursue a more formal effort to provide refinancing to the consumer.

In this manner, the consumer 110 conveniently learns about available loan products that may substantially improve that consumer's debt configuration. The matching financial institution 120, in turn, receives a lead on a consumer who might benefit from becoming a customer of that financial institution. The financial institution is then free to pursue that lead directly with the consumer.

Additionally and optionally, the LAS 100 may provide an additional service to the consumer by periodically revisiting (i.e., monitoring) the consumer's existing loans and the available replacement loans after the consumer has received an initial analysis via the method described in FIG. 5. In this manner, the consumer may be allowed to take advantage of new loan offerings at the matching financial institution as these offerings become available in the future.

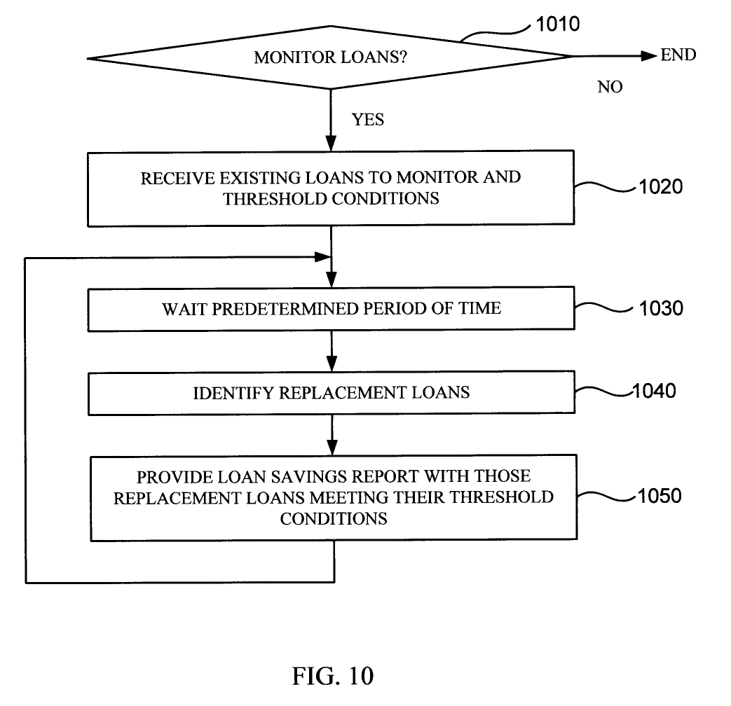

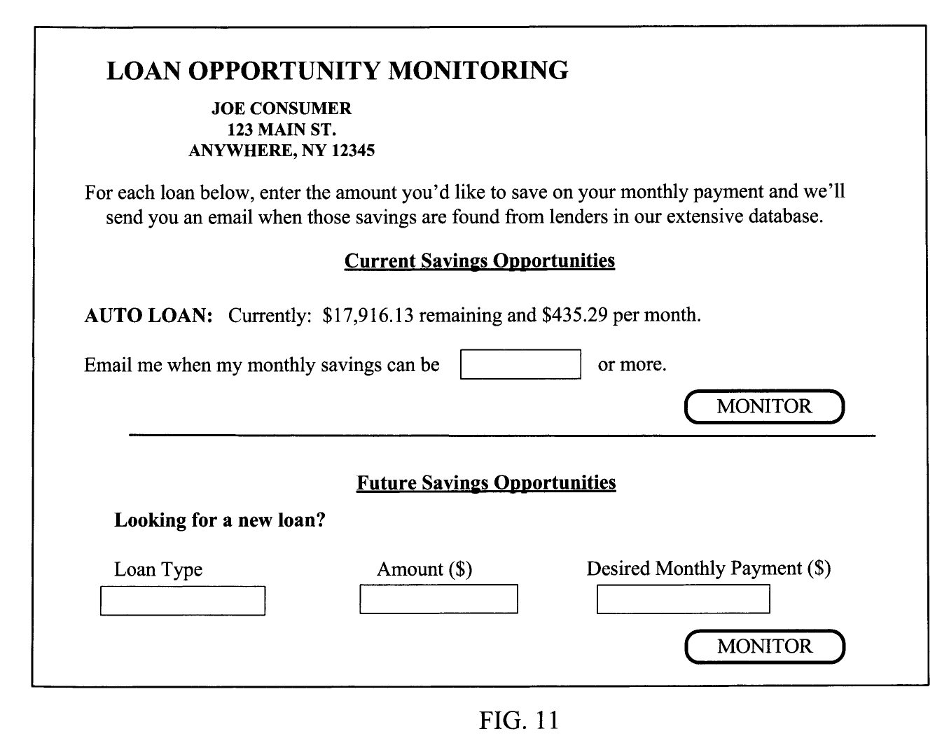

FIG. 10 shows an example of this optional loan monitoring portion of the illustrative direct-to-consumer method embodiment. Initially, in step 1010, the LAS offers the consumer 110 continued monitoring of replacement loan opportunities. Such an offer may be made to the consumer, for example, when providing the loan savings report to the consumer in step 540. If the consumer accepts this offer, the LAS continues to step 1020 and the consumer is given the opportunity to indicate which existing loans the consumer wishes to continue monitoring (the “monitored loans”) as well as to indicate a respective threshold condition for each monitored loan. The threshold condition for a particular monitored loan is that condition that must be achieved by a corresponding replacement loan before the LAS will bring that replacement loan to the attention of the consumer. The consumer may, for example, be presented with a Web page similar that shown in FIG. 11. On this illustrative Web page, under the heading “Current Savings Opportunities,” the consumer is reminded of the loan parameters associated with one of the consumer's existing loans (in this particular case, an auto loan). Below this reminder, the consumer is allowed to enter the threshold condition for this existing loan and to activate monitoring. In this case, the threshold conditions requires that a replacement loan reduce the consumer's monthly auto loan payment by at least the entered dollar amount in relation to the consumer's existing loan before the LAS will bring that replacement loan to the attention of the consumer.

Next, in step 1030, the LAS waits a predetermined period of time. This time period may, for example, consist of one month, although any other time period may be chosen (e.g., one week). In step 1040, the LAS 100 identifies replacement loans for each of the monitored loans. This process is performed in manner similar to that described above with regard to steps 535. In step 1050, the loan parameters of any identified replacement loans are compared to their respective existing monitored loans. Finally, in step 1060, the LAS presents those replacement loans meeting their threshold conditions to the consumer in the form of a loan savings report. Those replacement loans not meeting their threshold conditions are not presented. Subsequently, the LAS returns to step 1030 and continues the monitoring process. Ongoing monitoring for advantageous loan opportunities thereby continues.

It is also noted that, in the optional monitoring portion described in FIG. 10, the consumer may also be offered the ability to monitor the existence of desired loans (as opposed to just existing loans). Such desired loans may also be entered by the consumer on, for example, the Web page shown in FIG. 11 (“Future Savings Opportunities”). Here the consumer may enter that consumer's desired loan type, loan amount, and desired monthly payment. Later, while the LAS is searching for replacement loans to replace existing monitored loans, the LAS may also look for loans available at the matching financial institution which may meet the consumer's desired loan parameters. When so found, these matching loans may also be presented to the consumer in the form of a loan savings report.

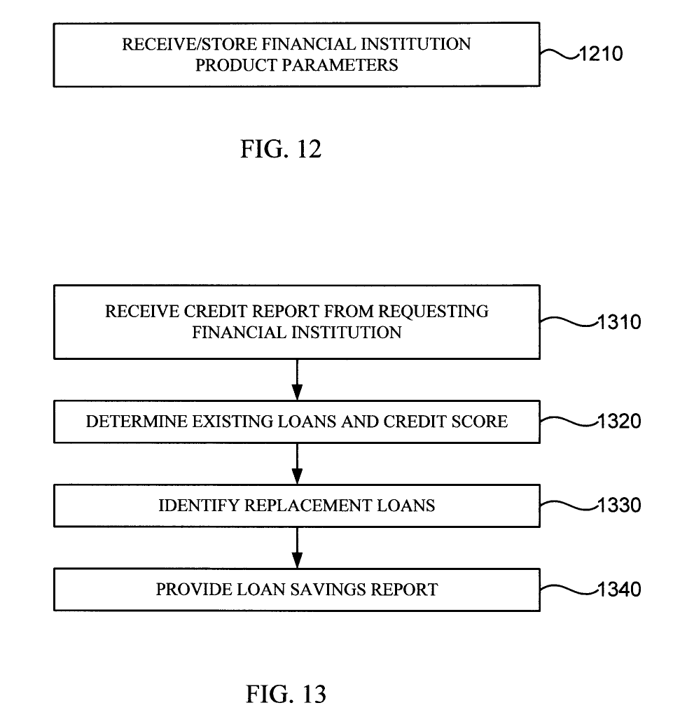

FIGS. 12 and 13 show flow charts of an additional “business-to-business” method embodiment of the invention. This second method embodiment can also be broken up into two portions: a configuration portion, and a loan analysis portion. In the business-to-business method embodiment, however, the LAS 100 provides loan analysis services directly to the financial institutions 120 rather than to the consumers 110 via the Internet. For this reason, the business-to-business method embodiment may use the same elements shown in FIG. 1, but does not require that the consumers be able to access the network 150.

The configuration portion of the business-to-business method embodiment is shown in FIG. 12 and comprises a single step 1210. This step comprises receiving FIPPS from those financial institutions 120 that wish to participate in the loan analysis solution. It is performed in the same manner as step 210, described above. However, the loan analysis portion of the method, which is described in the flow chart in FIG. 13, is predicated on several actions occurring before the LAS 100 provides any loan analysis services. More specifically, the consumer 110 will preferably have contacted a particular financial institution 120 capable of providing loan services to that consumer (the “requesting financial institution”), and the requesting financial institution will have taken those actions required to obtain a credit report for the consumer. In addition, the requesting financial institution will have made contact with the LAS and will have requested a loan savings report.

The loan analysis portion of the business-to-business method starts with step 1310. In this step, the LAS 100 receives the credit report for the consumer 110 directly from the requesting financial institution 120. Next, in step 1320, the LAS parses the credit report in accordance with the method described in step 530 in order to determine the consumer's existing loans and credit score. In step 1330, the LAS then identifies the replacement loans in accordance with the method described in step 535. Finally, in step 1340, the LAS provides the loan savings report to the requesting financial institution. This loan savings report will comprise comparison data similar to that shown in FIG. 9.

Once so obtained, the loan savings report will allow the requesting financial institution 120 to readily determine the consumer's existing loans and what loan products available at the financial institution may be used to improve the consumer's debt configuration. In this way, the loan savings report becomes a compelling tool with which to sell loan products to the consumer 110. Moreover, neither the consumer nor the requesting financial institution has been required to manually enter any existing loan parameters or perform any financial computations.

It should again be emphasized that the above-described embodiments of the invention are intended to be illustrative only. Other embodiments can use different types and configurations of elements for implementing the described functionality. These numerous alternative embodiments within the scope of the appended claims will be apparent to one skilled in the art.

Moreover, all the features disclosed herein may be replaced by alternative features serving the same, equivalent, or similar purpose, unless expressly stated otherwise. Thus, unless expressly stated otherwise, each feature disclosed is one example only of a generic series of equivalent or similar features.

What is claimed is:

1. A method of providing loan analysis for a consumer eligible to receive loan services from a particular financial institution, the method to be performed by a data processing system and comprising the steps of:
determining every existing loan of the consumer reflected in a credit report from the credit report;
matching each of the determined existing loans having a loan type that is offered by the particular financial institution with a respective replacement loan available at the particular financial institution; and
reporting a comparison of one or more determined existing loans with one or more matched replacement loans.

2. The method of claim 1, wherein the particular financial institution comprises a credit union.

3. The method of claim 1, wherein the particular financial institution has a restricted field of membership.

4. The method of claim 1, further comprising the step of storing parameters describing a plurality of replacement loans available at a plurality of different financial institutions.

5. The method of claim 1, further comprising the step of storing parameters describing a plurality of fields of membership at a plurality of different financial institutions.

6. The method of claim 1, further comprising the step of receiving information from the consumer relating to the eligibility of the consumer to receive loan services at the particular financial institution.

7. The method of claim 1, wherein the credit report is obtained from a credit bureau.

8. The method of claim 1, wherein the determining step comprises parsing contents of one or more tradelines in the credit report.

9. The method of claim 1, wherein the determining step comprises converting the credit report to a format in accordance with the Extensible Mark-up Language.

10. The method of claim 1, wherein the matching step comprises selecting a replacement loan for each determined existing loan based at least in part on the respective existing loan's loan type and remaining term.

11. The method of claim 1, wherein the matching step comprises selecting a replacement loan for each determined existing loan with a term equal to or greater than the remaining term of the respective existing loan.

12. The method of claim 1, wherein the matching step comprises utilizing a credit score for the consumer.

13. The method of claim 12, wherein the credit score for the consumer is determined from the credit report

14. The method of claim 1, wherein the reporting step comprises providing a report that compares the monthly payment of an existing loan with the monthly payment of a matched replacement loan.

15. The method of claim 1, further comprising the step of providing the credit report to the consumer.

16. The method of claim 1, wherein the reporting step comprises generating a report accessible directly by the consumer via the Internet.

17. The method of claim 1, wherein the reporting step comprises generating a report accessible by the particular financial institution.

18. The method of claim 1, comprising the steps, to be performed at a predetermined time after performing the matching step of claim 1, of:
further matching a particular determined existing loan having a loan type that is offered by the particular financial institution with a replacement loan available at the particular financial institution; and
further reporting a comparison of the particular determined existing loan with its further matched replacement loan if a predetermined threshold condition is met.

19. The method of claim 18, wherein the further reporting step is performed if a monthly payment of the further matched replacement loan is a predetermined amount lower than a monthly payment of the particular existing loan.

20. The method of claim 19, wherein the predetermined amount is determined by the consumer.

21. The method of claim 1, further comprising the steps of:
receiving a desired loan from the consumer;
matching the desired loan with a respective replacement loan available at the particular financial institution; and
reporting a comparison of the desired loans with the respective matched replacement loan.

22. A data processing system operative to provide loan analysis for a consumer eligible to receive loan services from a particular financial institution, the data processing system comprising:
a memory portion; and
a data processor connected to the memory, the data processor operative to determine every existing loan of the consumer reflected in a credit report from the credit report, match each of the determined existing loans having a loan type that is offered by the particular financial institution with a respective replacement loan available at the particular financial institution, and report a comparison of one or more determined existing loans with one or more matched replacement loans.
